(19) United States
(12) Patent Application Publication
(10) Pub. No.: US 2025/0035924 A1
(43) Pub. Date: Jan. 30, 2025

(54) WAVEGUIDE FOR AN AUGMENTED REALITY OR VIRTUAL REALITY DISPLAY

(71) Applicant: Snap Inc., Santa Monica, CA (US)

(72) Inventors: Ciaran Padraic Phelan, Abingdon (GB); Matthew Proctor, Reading (GB); Kai Wang, St. Albans (GB); Parashara Panduranga, Banbury (GB); David Louis Maxime Poussin, London (GB)

(21) Appl. No.: 18/716,461

(22) PCT Filed: Dec. 9, 2022
(86) PCT No.: PCT/EP2022/085201

§ 371 Date: Jun. 4, 2024

(30) Foreign Application Priority Data
Dec. 10, 2021 (EP) 21213715.2

(51) Int. Cl. G02B 27/01; F21V 8/00

(52) U.S. Cl. CPC G02B 27/0101; G02B 6/0036; G02B 6/0016; G02B 2027/0116

(57) ABSTRACT

A waveguide for use in an augmented reality or virtual reality display, comprising: a waveguide substrate layer having a planar surface; and a plurality of optical structures extending into or out of the planar surface;

wherein the plurality of optical structures are arranged in an array to provide at least one diffractive optical element in the waveguide, and the at least one diffractive optical element is configured to receive light from an input direction within the plane of the waveguide and to diffract a portion of the received light out of the waveguide towards a viewer;

wherein, in a plane defined by the input direction and a direction perpendicular to the planar surface, at least one of the optical structures has a cross-section comprising a top edge, a first side edge and a second side edge, the first side edge extends from the planar surface to a leading end of the top edge, the top edge extends from the leading end in a major direction parallel to the input direction to a following end, and the second side edge extends from the following end of the top edge to the planar surface,

wherein: the first side edge has a first oblique major direction away from the planar surface where the first oblique major direction is neither parallel to the planar surface nor perpendicular to the planar surface, and/or the second side edge has a second oblique major direction towards the planar surface where the second oblique major direction is neither parallel to the planar surface nor perpendicular to the planar surface.

### TECHNICAL FIELD

The present invention relates to a waveguide for use in an augmented reality or virtual reality display. In particular, the invention relates to a waveguide in which light is coupled out of a waveguide towards a viewer.

### BACKGROUND

In a normal augmented reality set-up, a transparent display screen is provided in front of a user so that they can continue to see the physical world. The display screen is typically a glass waveguide, and a projector is provided to one side. Light from the projector is coupled into the waveguide by a diffraction grating. The projected light is totally internally reflected within the waveguide. The light is then coupled out of the waveguide by another diffraction grating so that it can be viewed by a user. The projector can provide information and/or images that augment a user's view of the physical world.

Additionally, a waveguide can expand light in one or two dimensions by arranging a diffractive optical element DOE (e.g. a diffraction grating) to extend along a surface of the waveguide such that light travelling within the waveguide by total internal reflection can interact with the DOE multiple times at multiple interaction points along the waveguide, diffracting a portion of the light in a new direction at each of the interaction points.

For example, diffractive waveguide combiners have been used in the development of displays for augmented reality and virtual reality devices. Such diffractive waveguide combiners are made of at least one waveguide substrate which in turn includes at least one input region, which receives an input image from a projector, and at least one output region, which receives the input image from the input region, replicates it along an eyebox and redirects those replicated input images towards the eye of a viewer looking through the display.

However, when light interacts with a DOE multiple times, the brightness of the non-diffracted light is reduced with each interaction meaning that, when the light is observed, the brightness is non-uniform along the direction of expansion. If this non-uniformity is strong enough, it may be perceived when light from the waveguide is viewed. For example, prior art nanostructure element arrays can give rise to undesirable distribution or unsatisfactory uniformity of luminance.

WO 2018/178626 describes one example related to this problem. In WO 2018/178626, diffractive 2D expansion of light within a waveguide may be less efficient than the direct diffraction out of the waveguide, producing a bright central strip. This is solved by modifying the cross-sectional shape of optical structures in the plane of the waveguide.

Still, it is desirable to provide alternative ways of modifying the diffraction of a diffractive optical element.

### SUMMARY

According to a first aspect of the invention, there is provided a waveguide for use in an augmented reality or virtual reality display, comprising: a waveguide substrate layer having a planar surface; and a plurality of optical structures extending into or out of the planar surface;

wherein the plurality of optical structures are arranged in an array to provide at least one diffractive optical element on or in the waveguide, and the at least one diffractive optical element is configured to receive light from an input direction within the plane of the waveguide and to diffract a portion of the received light out of the waveguide towards a viewer;

wherein, in a plane defined by the input direction and a direction perpendicular to the planar surface, at least one of the optical structures has a cross-section comprising a top edge, a first side edge and a second side edge, the first side edge extends from the planar surface to a leading end of the top edge, the top edge extends from the leading end in a major direction parallel to the input direction to a following end, and the second side edge extends from the following end of the top edge to the planar surface,

wherein: the first side edge has a first oblique major direction away from the planar surface where the first oblique major direction is neither parallel to the planar surface nor perpendicular to the planar surface, and/or the second side edge has a second oblique major direction towards the planar surface where the second oblique major direction is neither parallel to the planar surface nor perpendicular to the planar surface.

As the inventors have found, by configuring at least one of the side edges of an optical structure to be neither parallel to nor perpendicular to the planar surface, the out-coupling efficiency of the diffractive optical element including the optical structure can be increased or decreased, relative to the efficiency of conventional diffractive optical elements comprising discrete optical structures having rectangular cross-sections. This provides a further way to control the efficiency of a diffractive optical element and can, for example, be used to improve the uniformity of expanded light output by a waveguide.

Please note that, in the above, “parallel to the planar surface” would correspond to a completely flat surface in which the first or second side edge is flush with the planar surface, and “perpendicular to the planar surface” corresponds to an optical structure which corresponds to prior art configurations.

The first aspect is defined in terms of edges having “major directions”. This reflects the fact that different techniques for manufacturing optical structures have different degrees of precision, and the defined edges may not be perfectly straight edges meeting at well-defined angles. The described effects of the invention are nevertheless present so long as characteristic directions (e.g. average directions) of the edges have the recited features.

Preferably, in a case where both of the first and second side edges have an oblique major direction, an angle between the first oblique major direction and the input direction may be equal to an angle between the second oblique major direction and the input direction. In other words, the first and second side edges are arranged with reflective symmetry. This avoids offsetting the positions of the centers of the optical structures, and may simplify prediction of the effect of changing the angle of the oblique sides relative to the plane of the waveguide.

Preferably, an angle between the first or second oblique major direction and the input direction is lower than 90°. The inventors have found that this configuration increases the efficiency of out-coupling. This may be desirable to increase the brightness of light diffracted out of the waveguide at a position which is relatively dim (for example a position outside of the bright central strip described in WO2018/178626).

Preferably, an angle between the first or second oblique major direction and the input direction is greater than 90°. The inventors have found that this configuration decreases the efficiency of out-coupling. This may be desirable to decrease the brightness of light diffracted out of the waveguide at a position which is relatively bright (for example a position inside the bright central strip described in WO2018/178626).

Preferably, an angle between the first or second major direction and the input direction decreases as a function of displacement in the input direction (X) for each respective optical structure. As discussed as background, non-uniformity in an expanded image from a waveguide can arise because too much light is output in early interactions with the diffractive optical element along the path of light guided in the waveguide, and too little light remains to be output in later interactions with the diffractive optical element. By modifying the optical structures in a systematic way as a function of position, this can be compensated by providing decreased diffraction efficiency for the early interactions and increased diffraction efficiency for the later interactions.

Preferably, at least one of the optical structures comprises an optical coating. Coatings are a known way of modifying diffraction efficiency, which can be combined with the use of an oblique edge in the optical structures to provide a further modification of diffraction efficiency. For example, the optical coating may comprise at least one of TiO₂, SiO₂, Nb₂O₅, HfO₂.

However, some coating techniques may leave a gap in cases where the optical structure includes an undercut between a side edge and the planar surface, or even when a side edge is perpendicular to the planar surface. Accordingly, in order to provide a complete coating, a coating technique may be modified to explicitly include a step of coating the side edge(s).

The optical structures of the first aspect may be provided as external surface features, by designing the planar surface of the waveguide substrate layer to be an air interface. Alternatively, the optical structures of the first aspect may be provided as a photonic crystal in which the planar surface of the waveguide substrate layer is an interface between two substrates having different refractive indices. Of course, if the planar surface has a region away from the optical structures which is an air interface or otherwise, this is not relevant for the present invention.

Optionally, the first aspect can be combined with the further structural features of the optical structures in the plane of the waveguide, as described in WO 2018/178626. This can provide increased control of diffraction efficiency in multiple modes within the waveguide and out of the waveguide.

More specifically, optionally, the plurality of optical structures are arranged in an array to provide at least two diffractive optical elements overlaid on one another in the waveguide, wherein each of the two diffractive optical elements is configured to receive light from an input direction and couple it towards the other diffractive optical element which can then act as an output diffractive optical element providing outcoupled orders towards a viewer, wherein the at least one of the plurality of optical structures has a shape, when viewed in the plane of the waveguide, comprising a plurality of substantially straight sides having respective normal vectors at different angle.

As a first implementation option in the case where two diffractive optical elements are overlaid, when viewed in the plane of the waveguide, one of the sides may have a length that is a ratio of around 0.1 to 0.4 of the spacing of optical structures in the array.

As a second implementation option in the case where two diffractive optical elements are overlaid when viewed in the plane of the waveguide, the at least one optical structure may include sides that are substantially parallel to the two respective diffractive optical elements.

As a third implementation option in the case where two diffractive optical elements are overlaid when viewed in the plane of the waveguide, the at least one optical structure may include sides that are angled at substantially ±30° to the input direction.

As a fourth implementation option in the case where two diffractive optical elements are overlaid when viewed in the plane of the waveguide, the input direction defines an input axis, and the optical structures have different shapes at positions which are tangentially displaced from the input axis in the plane of the waveguide.

In some implementations, when viewed in one of plurality of planes parallel to the plane of the waveguide and offset by different distances z from the plane of the waveguide, the at least one optical structure has a parallelogram (or more specifically rhombus) shaped structure. Furthermore, in the parallelogram shaped structure, at least one corner of the rhombus may be inverted to protrude inward rather than outward, forming a notch with sides of length n. In such implementations, n may be fixed regardless of the distance z. Alternatively, the length n may vary as a function of the distance z. It has been found that varying n as a function of distance z increases the uniformity of light across a field of view. For example, n may vary proportionally with the perimeter or area of the parallelogram cross-section.

In some implementations, when viewed in one of a plurality of planes parallel to the plane of the waveguide and offset by different distances z from the planar surface: a perimeter of the optical structure increases as a function of the distance z; or a perimeter of the optical structure decreases as a function of the distance z.

The planar waveguide may also comprise an input diffractive optical element configured to couple light into the waveguide and to provide light to the plurality of optical structures in the array in the input direction.

According to second aspect, the following disclosure provides a diffractive waveguide combiner for an augmented reality or virtual reality display, comprising: a waveguide; an input region; a first array of diffractive nanostructures arranged as a combined expansion and output region configured to receive a pupil of image bearing light from the input region and replicate the pupil across the array before directing the replicated pupil towards the eye of a viewer, wherein each diffractive nanostructure is a three dimensional object comprising a plurality of sidewalls, a lower boundary and an upper boundary, the lower and upper boundaries being parallel to each other and having different areas; and optionally the combined expansion and output region additionally comprising one or more additional arrays of nanostructures different to the first array of diffractive nanostructures.

In an embodiment of the second aspect, the area of the upper boundary is greater than that of the lower boundary.

In another embodiment of the second aspect, the area of the upper boundary is lower than that of the lower boundary.

In embodiments of the second aspect, each sidewall may be contained within a plane and at an angle relative to the lower and upper boundaries. The angle is preferably greater than 0° and lower than 90°.

### BRIEF DESCRIPTION OF THE DRAWINGS

Embodiments of the invention are now described, by way of example, with reference to the drawings, in which:

FIG. 1 is a top view of a known waveguide;

FIG. 2 is another top view of a known waveguide;

FIGS. 3A to 3C are cross-section views of optical structures for use in a diffractive optical element;

FIG. 3D is a graph of out-coupling efficiency for each of the structures in FIGS. 3A to 3C;

FIGS. 4A to 4C are cross-section views of optical structures for use in a diffractive optical element;

FIG. 4D is a graph of out-coupling efficiency for each of the structures in FIGS. 4A to 4C;

FIGS. 5A to 5C are cross-section views of optical structures for use in a diffractive optical element;

FIG. 5D is a graph is a graph of out-coupling efficiency for each of the structures in FIGS. 5A to 5C;

FIG. 6 is a top view of a photonic crystal for use in a waveguide in an embodiment of the invention;

FIG. 7 shows a number of examples of optical structures with different shapes that can be used in a photonic crystal in a waveguide in an embodiment of the invention;

FIG. 8 is a top view of a photonic crystal for use in a waveguide in an embodiment of the invention;

FIG. 9 is a graph showing how diffraction efficiency varies with notch width for an optical structure with a particular shape, in an embodiment of the invention;

FIG. 10 is another graph showing how diffraction efficiency varies with flat sided width for an optical structure with another shape, in an embodiment of the invention;

FIGS. 11A and 11B are 3D wireframe drawings of examples of 3D optical structures corresponding to FIGS. 6 and 8;

FIGS. 12A and 12B are 3D wireframe drawings of examples of 3D optical structures corresponding to FIG. 11A, with undercut or overcut sidewalls;

FIGS. 13A to 13D are 3D wireframe drawings of examples of 3D optical structures corresponding to FIG. 11B, with undercut or overcut sidewalls;

FIGS. 14A to 14C are top and side cross-section drawings of 3D optical structures corresponding to FIG. 11B, with undercut sidewalls at different angles;

FIG. 15 is cross-sectional electron micrograph through a waveguide, showing surface features including different sidewall angles;

FIGS. 16A and 16B are graphs showing uniformity of luminance across the field of view, as a function of sidewall angle;

FIG. 17 is a table of properties of waveguides, where the right-hand column indicates a change in properties of white light seen from a waveguide as a result of changing the sidewall angle of optical structures;

FIGS. 18A and 18B are top-facing and perspective views of an alternative square grating photonic crystal structure.

### DETAILED DESCRIPTION

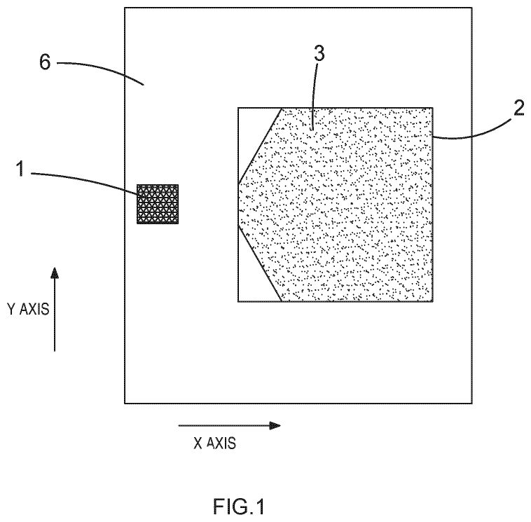

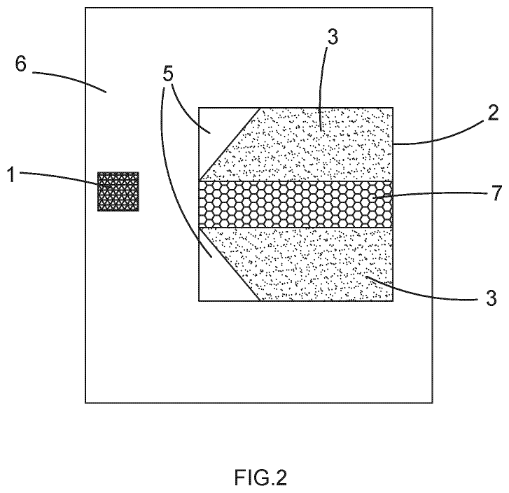

FIGS. 1 and 2 are top views of a known waveguide 6 to which the following described invention may be applied. In the known waveguide, an input diffraction grating 1 is provided in or on a surface of the waveguide 6 for coupling light from a projector (not shown) into the waveguide 6. The waveguide 6 is formed of a defined refractive index material such as glass or plastic. Light that is coupled into the waveguide travels by total internal reflection towards an output element 2, which includes a photonic crystal 3.

In a typical application, a projector introduces rays of image light to the input diffraction grating 1, where the image light defines an image pupil, which represents a full image (i.e. contains all the angular information that defines an image) that an individual could perceive if their eye was correctly aligned with the image pupil. The photonic crystal 3 comprises an arrangement of nanostructure elements designed so that light guided in the waveguide splits and spreads to cover the whole area of the output element 2, thus replicating the image pupil. At the same time, at each interaction with the nanostructure elements, a proportion of the light of an image pupil is guided towards the eye of an individual using the waveguide.

More specifically, in this example, the photonic crystal 3 includes pillars (not shown) having a circular cross-sectional shape from the perspective of these top views. The pillars have a different refractive index relative to the refractive index of the surrounding waveguide medium and they are arranged in an array having hexagonal symmetry.

As an alternative to using two different waveguide media with different refractive indices, the pillars can also be provided as surface structures at an interface between the waveguide medium and air. The pillars may be configured as protrusions from the waveguide body or recesses into the waveguide body.

When light encounters the photonic crystal 3 in the output element 2 from the input diffraction grating along the x-axis it is either transmitted or turned through +60° by one of the diffractive optical structures formed by the array in the photonic crystal 3.

It has been found that the output image diffracted from element 2 includes a central stripe 7 which has a higher relative brightness than other parts. It is believed that this effect is created due to the diffraction efficiencies of the diffractive optical structures formed by the array in the photonic crystal 3. In particular, it is believed that a significant proportion of light received from the input diffraction grating 1 is diffracted to the eye when it encounters the photonic crystal 3, rather than being diffracted and turned through +60°.

The invention can also be applied to other waveguides comprising a diffractive optical element for coupling light out of the waveguide. For example, the invention may be applied to diffractive optical elements comprising a plurality of parallel grating lines, each grating line having a cross-section in a plane perpendicular to the lines.

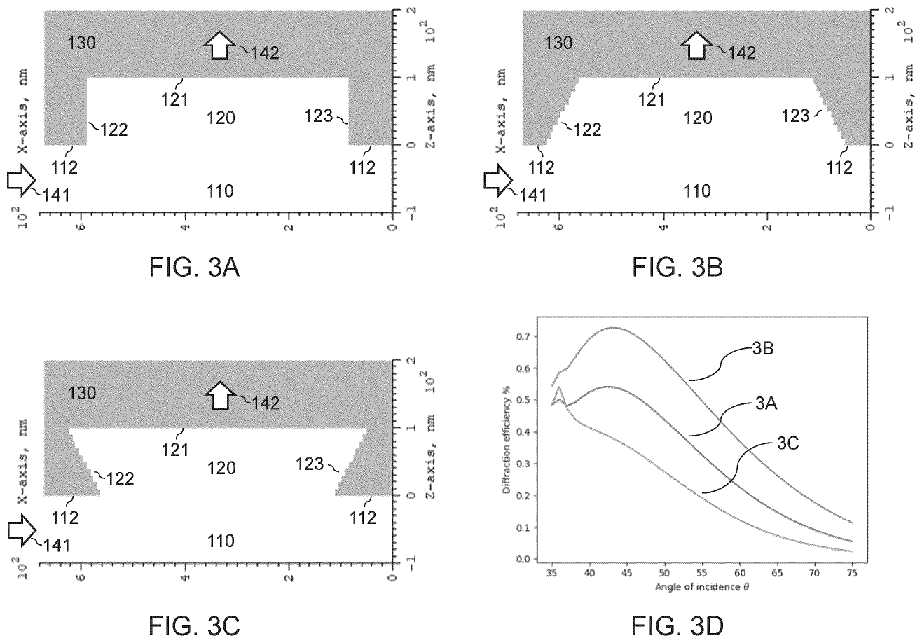

FIGS. 3A to 5D will now be used to discuss a cross-sectional shape of optical structures in a “vertical” plane perpendicular to a plane of the waveguide 6. This plane is defined by an input direction 141 within the plane of the waveguide 6 and an output direction 142 perpendicular to the plane of the waveguide 6. The input direction 141 is a direction in which light is guided within the waveguide and from which direction the light arrives at the output element 2. The output direction 142 is a direction in which light is diffracted out of the waveguide by the output element 2.

Referring now to FIG. 3A, the waveguide 6 comprises a waveguide substrate layer 110 having a planar surface 112. The planar surface 112 may for example be the top surface seen in FIGS. 1 and 2. The planar surface 112 may be a surface used for total internal reflection to guide light within the waveguide 6. Additionally, the planar surface 112 provides a reference plane from which a plurality of optical structures 120 are defined (only one of which is illustrated).

In the illustrated examples, the optical structures 120 extend out of the waveguide substrate layer 110 at the planar surface 112. Alternatively, the optical structures 120 may be recessed structures extending into the waveguide substrate layer 110 from the planar surface 112.

The planar surface 112 is an interface between a substrate material of waveguide substrate layer 110 and another material in layer 130. The layer 130 may simply be the exterior of the waveguide 6, in which case the planar surface 112 is an air interface, at which any refraction is substantially determined by the refractive index of the substrate material of the waveguide substrate layer 110. The optical structures 120 may have the same refractive index as the waveguide substrate layer 110 (for example they may be moulded or etched from a same material as the waveguide substrate layer 110 or they may result from imprinted resin (deposited on the waveguide substrate) whose refractive index is to be substantially the same as that of the waveguide substrate), or the optical structures 120 may have a different refractive index.

Alternatively, the planar surface 112 may be embedded within the waveguide 6. For example, a second substrate layer 130 may be formed to cover and protect the optical structures 120. In this case, the second substrate layer 130 has a refractive index different from the waveguide substrate layer 110. Again, the optical structures 120 may have the same or different refractive index as the waveguide substrate layer 110.

There is a third possibility in which the second substrate layer 130 has the same refractive index as the waveguide substrate layer 110 but a different refractive index from the optical structures 120. In this case, planar surface 112 is simply a theoretical reference for defining the shape and position of the optical structures 120 within the plane of directions 141 and 142, relative to some position along the illustrated z-axis.

As shown in FIGS. 3A to 3C, a cross-section of an optical structure 120 can be understood in terms of variations around a generally rectangular shape having a top edge 121 and two side edges 122, 123. The top edge 121 has a major direction parallel to the planar surface 112 and, in cases where the optical structures 120 extend out of the waveguide substrate layer 110, the top edge 121 is offset from the planar surface in the output direction 142. The two side edges 122, 123 connect the top edge 121 to the planar surface 112. In cases where the planar surface 112 is not a physical surface (i.e. just a theoretical reference) then the optical structure 120 has a fourth edge (not shown) having a major direction parallel to the top edge 121 and parallel to the plane of the planar waveguide 6.

More specifically, FIG. 3A shows a conventional structure type in which the two side edges 122, 123 are perpendicular to the planar surface 112. A diffractive optical element 2 comprising optical structures 120 having this configuration has a variable diffraction efficiency as a function of angle of incidence, as shown in FIG. 3D in the plot labelled 3A.

On the other hand, FIGS. 3B and 3C show optical structures 120 in which at least one of the side edges 122, 123 has a major direction that is oblique to the planar surface 112, i.e. neither parallel to the planar surface nor perpendicular to the planar surface.

In the example of FIG. 3B, the first side edge 122 has a first oblique major direction away from the planar surface 112 and the second side edge 123 has a second oblique major direction towards the planar surface 112.

In FIG. 3B, an angle between the first oblique major direction and the input direction 141 is equal to an angle between the second oblique major direction and the input direction 141. In other words, the optical structure 120 has a reflective symmetry in the plane of FIG. 3B, about a line perpendicular to the input direction 141.

Additionally, in FIG. 3B, the angle between the first and second oblique major directions and the input direction 141 is lower than 90°. In other words, both oblique side edges 122, 123 are sloped outwardly to provide a convex shape when combined with the top edge 121.

A diffractive optical element 2 comprising optical structures 120 having the configuration of FIG. 3B has a variable diffraction efficiency as a function of angle of incidence, as shown in FIG. 3D in the plot labelled 3B. It can be seen that the diffractive efficiency with this configuration is greater than the diffractive efficiency with the configuration of FIG. 3A.

In the example of FIG. 3C, the first side edge 122 again has a first oblique major direction away from the planar surface 112 and the second side edge 123 again has a second oblique major direction towards the planar surface 112.

In FIG. 3C, an angle between the first oblique major direction and the input direction 141 is again equal to an angle between the second oblique major direction and the input direction 141. In other words, the optical structure 120 has a reflective symmetry in the plane of FIG. 3C, about a line perpendicular to the input direction 141.

Additionally, in FIG. 3C, the angle between the first and second oblique major directions and the input direction 141 is greater than 90°. In other words, both oblique side edges 122, 123 are sloped inwardly to provide a shape that includes notches undercutting the top edge 121.

A diffractive optical element 2 comprising optical structures 120 having the configuration of FIG. 3C has a variable diffraction efficiency as a function of angle of incidence, as shown in FIG. 3D in the plot labelled 3C. It can be seen that the diffractive efficiency with this configuration is lower than the diffractive efficiency with the configuration of FIG. 3A.

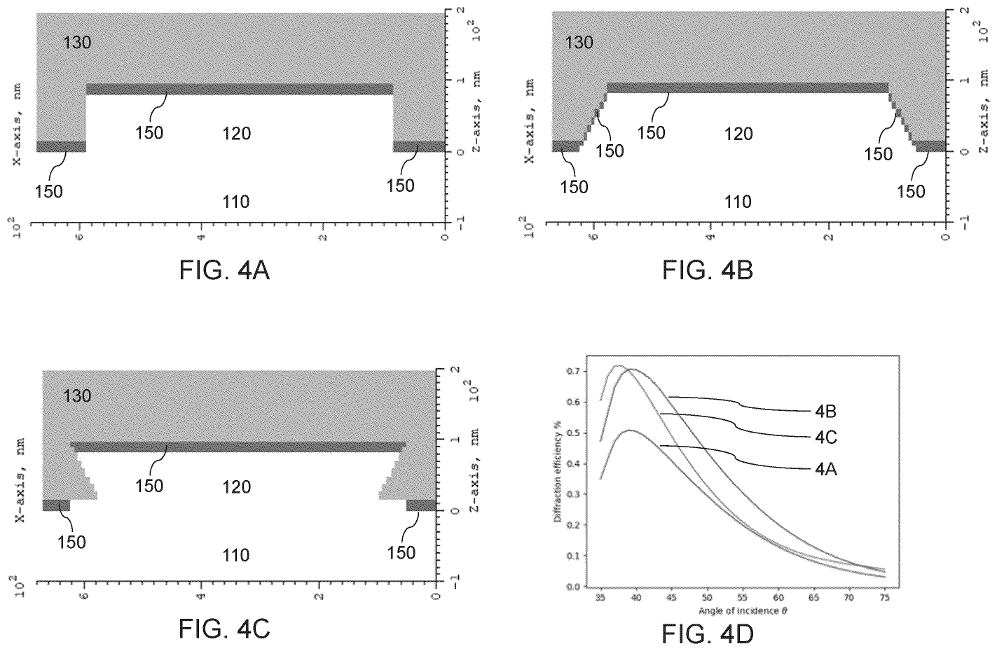

FIGS. 4A to 4C show similar structures to FIGS. 3A to 3C respectively, but with the addition of a coating 150. The coating is used to modify the diffraction efficiency of the diffractive optical element 2 and may, for example, comprise TiO₂.

Referring to FIG. 4A, the coating 150 may be deposited perpendicular to the planar surface 112 such that the coating is provided on the planar surface 112 and on the top edge 121 of the optical structure 120. A diffractive optical element 2 comprising optical structures 120 having this configuration has a variable diffraction efficiency as a function of angle of incidence, as shown in FIG. 4D in the plot labelled 4A.

Referring to FIG. 4B, when at least one of the side edges 122, 123 is configured such that the angle between the first or second oblique major direction and the input direction 141 is lower than 90°, then that side edge 122, 123 is exposed to be coated with the coating 150 in a perpendicular coating process.

A diffractive optical element 2 comprising optical structures 120 having the configuration of FIG. 4B has a variable diffraction efficiency as a function of angle of incidence, as shown in FIG. 4D in the plot labelled 4B. It can be seen that the diffractive efficiency with this configuration is greater than the diffractive efficiency with the configuration of FIG. 4A.

Referring to FIG. 4C, when at least one of the side edges 122, 123 is configured such that the angle between the first or second oblique major direction and the input direction 141 is greater than 90°, then that side edge 122, 123 is not exposed to be coated with the coating 150 in a perpendicular coating process. Furthermore, the undercutting of the top edge 121 means that a part of the planar surface 112 is also not exposed to be coated with the coating 150.

A diffractive optical element 2 comprising optical structures 120 having the configuration of FIG. 4C has a variable diffraction efficiency as a function of angle of incidence, as shown in FIG. 4D in the plot labelled 4C. It can be seen that the diffractive efficiency with this configuration is again greater than the diffractive efficiency with the configuration of FIG. 4A (contrary to the uncoated case).

In FIGS. 4A to 4C, it was assumed that the coating 150 is deposited perpendicular to the planar surface 112. This is commonly the case so that the location of the coating can be easily chosen on a planar substrate. However, other coating techniques are known to ensure that a surface is completely covered, for example by applying a coating from more than one direction.

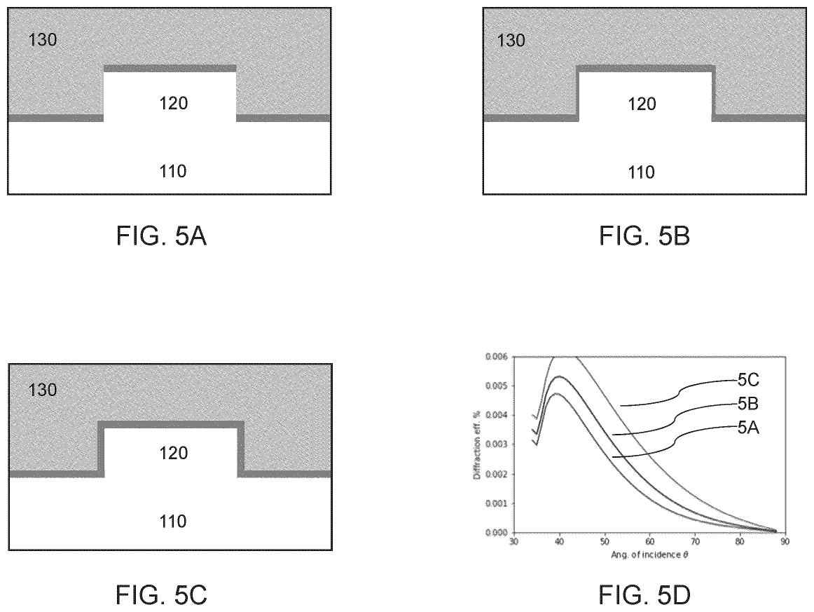

FIGS. 5A to 5D are used to illustrate the effects of a technique modified to include a more complete coating of the optical structure 120.

In FIG. 5A, the optical structure 120 is similar to FIG. 4A, and a diffractive optical element 2 comprising optical structures 120 having the configuration of FIG. 5A has a variable diffraction efficiency as a function of angle of incidence, as shown in FIG. 5D in the plot labelled 5A.

In FIG. 5B, the optical structure 120 is similar to FIG. 4A, but with the addition of a coating 150 on the side edges 122 and 123 which has a thickness lower than a thickness of the coating on the top edge 121 and on the planar surface 112. A diffractive optical element 2 comprising optical structures 120 having the configuration of FIG. 5B has a variable diffraction efficiency as a function of angle of incidence, as shown in FIG. 5D in the plot labelled 5B. It can be seen that the diffractive efficiency with this configuration is greater than the diffractive efficiency with the configuration of FIG. 5A.

In FIG. 5C, the optical structure 120 is similar to FIG. 4A, but with the addition of a coating 150 on the side edges 122 and 123 which has a thickness equal to a thickness of the coating on the top edge 121 and on the planar surface 112. A diffractive optical element 2 comprising optical structures 120 having the configuration of FIG. 5C has a variable diffraction efficiency as a function of angle of incidence, as shown in FIG. 5D in the plot labelled 5C. It can be seen that the diffractive efficiency with this configuration is greater than the diffractive efficiency with either of the configurations of FIGS. 5A and 5B.

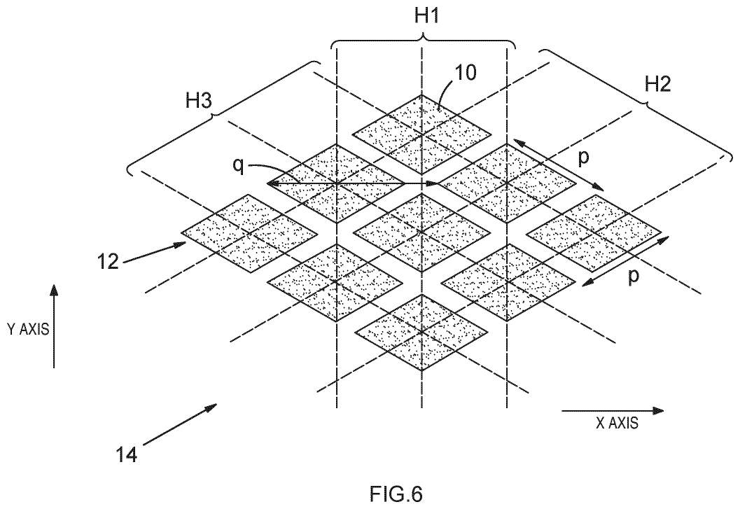

While FIGS. 3A to 5D have been used to discuss a cross-sectional shape of the optical structures in a plane defined by the directions 141 and 142, the optical structures also have an arrangement and cross-sectional shape in a perpendicular plane corresponding to the plane of the waveguide. Some possible arrangements and cross-sectional shapes of the optical structures within the plane of the waveguide will now be discussed with reference to FIGS. 6 to 8.

FIG. 6 is a top view of part of a photonic crystal 12, which is an array of optical structures 10 that are provided on or within a waveguide 14 and distributed within an x-y plane of the waveguide 14 perpendicular to the direction 142. The optical structures 10 in this arrangement are parallelograms having four substantially straight sides and four vertices. The optical structures 10 have substantially the same cross-sectional shape across the width of the waveguide. In other embodiments, the optical structures 10 may be provided across only a portion of the width of the waveguide 14.

The regular arrangement of optical structures 10 in the array may be thought of as a number of effective diffraction gratings or diffractive optical structures. In particular, it is possible to define a grating H1 with optical structures 10 aligned along the y-axis with adjacent rows of optical structures separated by a distance q. Grating H2 is arranged with rows of optical structures 10 at an angle of +30° to the x-axis, with adjacent rows separated by a distance p, known as the lattice constant. Finally, grating H3 is arranged with rows of optical structures at an angle of −30° to the x-axis, with adjacent rows separated by a distance p.

When light from an input grating received along the x-axis is incident on the photonic crystal 12 it undergoes multiple simultaneous diffractions by the various diffractive optical elements. Light can be diffracted into a zero order, which is a continuation of the propagation of the incident light. Light can also be diffracted into a first diffraction order by grating H1. The first diffraction order is coupled out of the waveguide 14 in a positive direction along the z-axis (direction 142 discussed above), towards a viewer. This first diffraction order can be defined as the straight to eye order. Light can also be diffracted into a first diffraction order by grating H2. This first diffraction order is diffracted at +60° to the x-axis, and this light beam goes on to make further interactions with the photonic crystal. Light can also be diffracted into a first diffracted order by grating H3. This first diffraction order is diffracted at +60° to the x-axis, and this light beam goes on to make further interactions with the photonic crystal. A subsequent diffractive interaction with the grating H2 can couple light out of the waveguide 12 in the positive z-axis towards a viewer. Thus, light can be coupled out of the waveguide at each point, and yet light can continue to expand within the waveguide 12 in two dimensions. The symmetry of the photonic crystal means that every exit beam has the same angular and chromatic properties as the input beam, which means that a polychromatic (as well as a monochromatic) light source may be used as the input beam with this photonic crystal arrangement.

The photonic crystal can allow simultaneous and rapid expansion of light in two dimensions so that the input light can fill a two-dimensional display screen. This can allow an ultra-compact display because the waveguide size can be kept to a minimum due to the two-dimensional beam expansion.

In this arrangement the optical structures 10 have straight sides that are parallel to the gratings H2, H3. Thus, the sides of the parallelograms are angled at ±30° to the x-axis, which is the direction along which input light is received from the input grating 1.

A surprising advantage has been found with non-circular optical structures 10 in the plane of the waveguide, which is that the diffraction efficiencies of the gratings H1, H2, H3 are significantly increased. This increases the proportion of light that is diffracted into the first orders by the gratings H1, H2, H3, and decreases the proportion of light that is diffracted into the zero order, and which continues to propagate in the waveguide 12 by total internal reflection. This can reduce the striping effect which has been observed with circular structures, which significantly improves the utility of the waveguide 14.

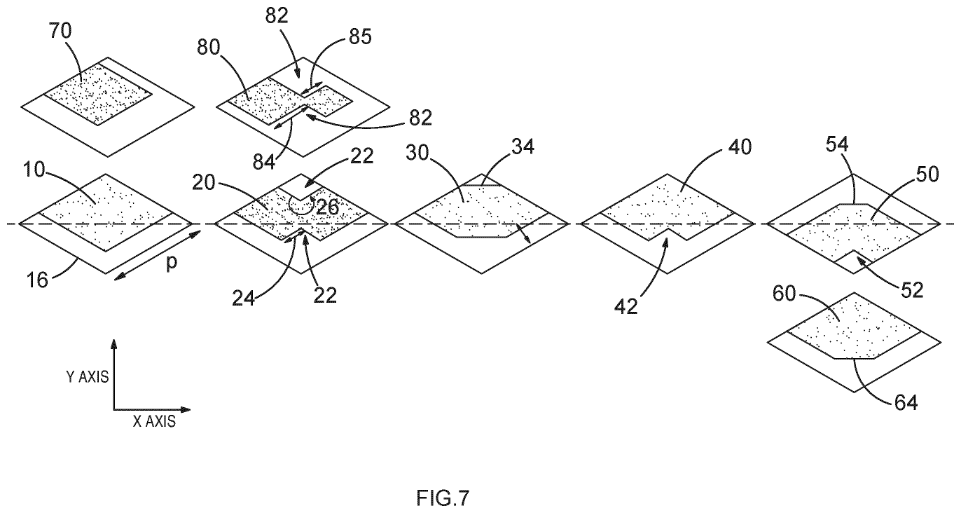

FIG. 7 shows a number of examples of other shapes for the optical structures 10 which can be used to further reduce the striping effect. A first optical structure 10 is a simple parallelogram, shown within a larger parallelogram 16, which indicates the spacing of optical structures 10 within the photonic crystal 12. A second optical structure 20 is a modified parallelogram having a pair of central notches 22. In this arrangement the notches 22 are formed of two sides which are parallel to respective main sides of the parallelogram. A notch width 24 can be defined. The notch 22 includes a vertex 26 having an internal angle which is larger than 180°. A third optical structure 30 is another modified parallelogram having two surfaces that are parallel to the x-axis. A “flat-sided” length 34 can be defined, which is the length of the side that is parallel to the x-axis. The third optical structure 30 has a plurality of vertices, each of which has an internal angle which is less than 180°. The first, second and third optical structures 10, 20, 30 have symmetry in the x-axis and the y-axis. A fourth optical structure 40 is provided, which is similar to the second optical structure 20, but includes only one notch 42. A fifth optical structure 50 is provided having a notch 52 on one side and a flat portion 54 on the other side which is parallel to the x-axis. A sixth optical structure 60 is provided, which is similar to the third optical structure 30, but with only one “flat sided” length 64. The fourth, fifth and sixth optical structures 40, 50, 60 have symmetry in the y-axis.

In all of the optical structures shown in FIG. 7 the polygons include sides that are substantially parallel to the gratings H1, H2 in the photonic crystal 12. However, other viable embodiments are envisaged where the optical structures have sides that are non-parallel to the gratings H1, H2.

Vertices are present in all of the optical structures shown in FIG. 7. In practice, these vertices would have slightly rounded corners, depending on the degree of magnification that is used when they are examined.

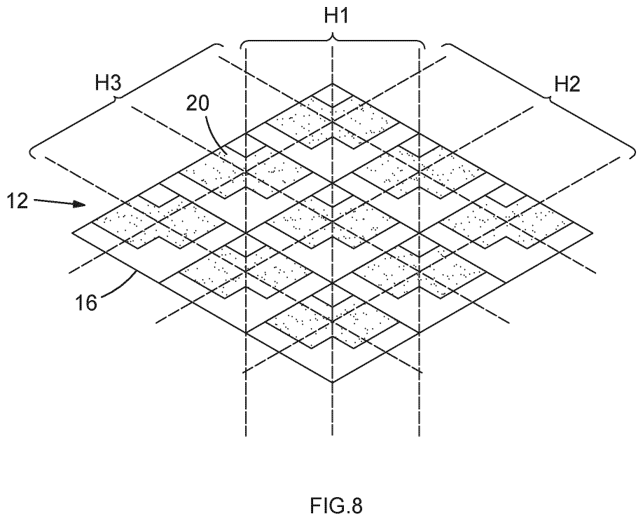

FIG. 8 is an example of a photonic crystal 12 with a regular array of the second optical structures 20.

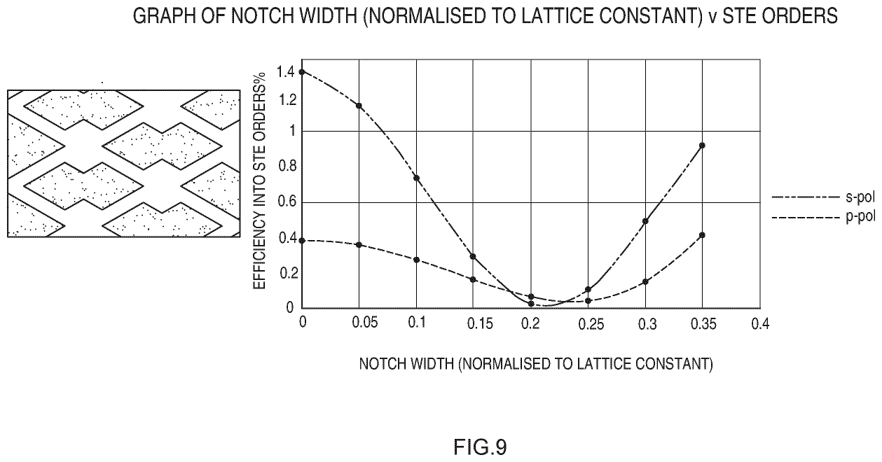

FIG. 9 is a graph showing the efficiency with which light is coupled into the straight to eye order when it interacts with the photonic crystal 12 as shown in

FIG. 8, formed by an array of the second optical structures 20. The graph shows how the efficiency of the straight to eye order varies when the notch width 24 is varied (while maintaining symmetry in the x-axis and the y-axis). The efficiency is plotted for the s-polarisation and p-polarisation. In this graph the s-polarisation has the higher efficiency when the notch width is zero. It is noted that a notch width of zero would actually correspond to the simple parallelogram shape of the first optical structure 10. It can be seen that the straight to eye diffraction efficiency is reduced to a minimum when the notch width 24 is in the range of 0.15 to 0.25of the lattice constant, p. In practice, the lattice constant, p, is selected in part based on the central wavelength of light that is intended for use in the waveguide.

It is evident from FIG. 9 that effective suppression of light that is coupled into the straight to eye order can be achieved through the use of a photonic crystal with a regular array of the second optical structures, as shown in FIG. 8, where the notch width 24 is in the range of 0.15 to 0.25 of the lattice constant, p. In practice, it may be desirable to avoid reducing the efficiency entirely to zero, otherwise an absence of light may create an effective dark stripe in the output image.

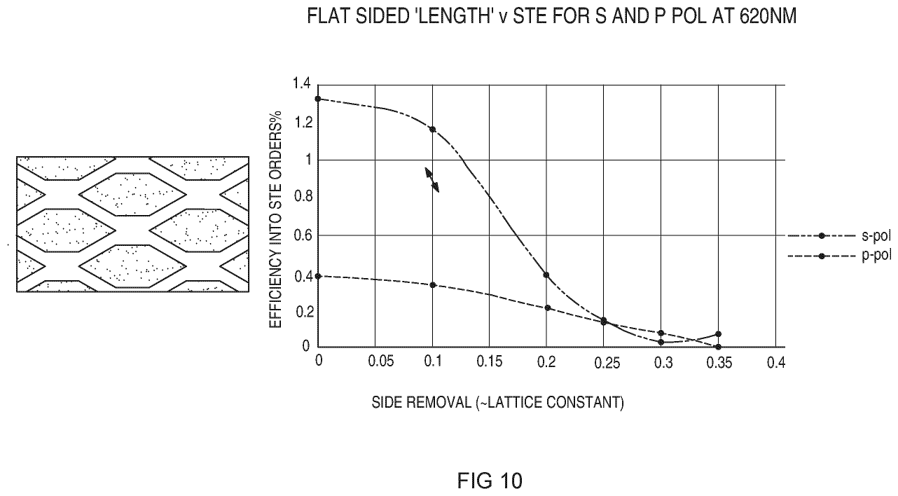

FIG. 10 is a graph showing the efficiency with which light is coupled into the straight to eye order when it interacts with a photonic crystal 12, formed by an array of the third optical structures 30. The graph shows how the efficiency varies when the flat sided length 34 is varied (while maintaining symmetry in the x-axis and the y-axis). The efficiency is plotted for the s-polarisation and p-polarisation. In this graph the s-polarisation has the higher efficiency when the flat sided width is zero. It is noted that a flat sided width of zero would actually correspond to the simple parallelogram shape of the first optical structure 10. It can be seen that diffraction efficiency is reduced to a minimum when the flat sided width 34 is in the range of 0.25 to 0.35 of the lattice constant, p.

Contrary to WO 2018/178626, according to the present disclosure the x-y cross-sections of optical structures discussed above with reference to FIGS. 6 to 8 are extended out of a plane of the waveguide such that they have sidewalls which are neither perpendicular to nor parallel to the plane of the waveguide.

The vertical profile, as well as the two-dimensional outline at the base of the optical structure, will affect the diffraction characteristics and behaviour of incident light rays as they propagate through the waveguide. Therefore, both the sidewall profile and two-dimensional outline (x-y plane view) will contribute to the quality and uniformity of the image perceived by an individual looking through the waveguide.

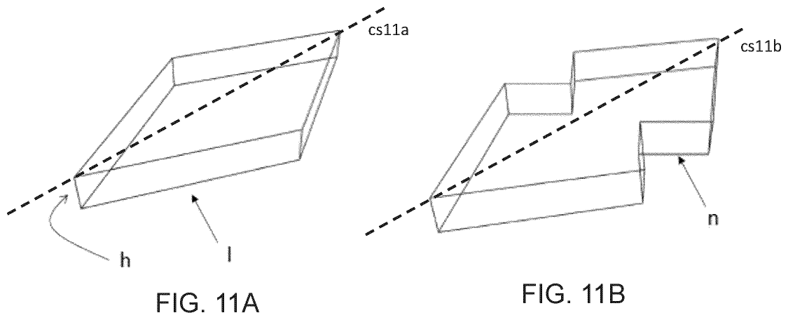

FIGS. 11A and 11B depict three three-dimensional representations of the nanostructures depicted in FIGS. 6 and 8. FIG. 11A depicts a rhombus shaped structure that has a height, h, which represents the thickness of the nanostructure and a sidewall length, I. The internal angles of the rhombus are defined by the angle between the lattice vectors of the two-dimensional grating array. For a hexagonal lattice, the angle is 30 degrees.

FIG. 11B depicts a rhombus shaped structure, with similar physical dimensions to the nanostructure depicted in FIG. 11A, with the exception that indentations, or ‘notches’, are formed that have edges with length n, similarly to FIG. 8. The inclusion of notches in the structure of FIG. 11B serves to control certain diffraction orders, in particular the straight-to-eye orders, which cause image light to be directed immediately out of the waveguide towards the eye of an individual looking through the waveguide. At each interaction with an optical structure, a proportion of the light in the waveguide is diffracted out of the waveguide, and the amount of light remaining to be replicated in further pupils across the output region is diminished. It is desirable for each ray of image light to undergo one or more turns within the array of nanostructures to replicate the number of pupils that can be viewed by an individual. The presence of the notch feature in the nanostructure of FIG. 11B promotes further turn orders within the output region (and effectively decreases the straight-to-eye orders), thereby promoting homogeneous propagation of light across the grating via pupil replication.

In FIGS. 11A and 11B, the sidewalls of the optical structure are perpendicular to the plane of the waveguide. As a result, the lines cs11a and cs11b indicate positions of cross sections which would look similar to FIG. 3A.

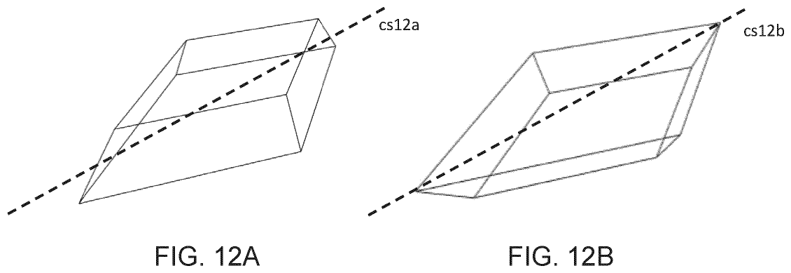

FIGS. 12A and 12B represent variations of the structure shown in FIG. 11A, with oblique sides. In FIG. 12A, the oblique sides are arranged such that an upper surface has a smaller area than a base of the optical structure. FIG. 12A corresponds to the cross-section shown in FIG. 3B above. In FIG. 12B, the oblique sides are arranged such that the area of the upper surface is larger than the area of the lower surface. As a result, the sidewall of the nanostructure is described as having a negative slope, or an undercut. FIG. 12B corresponds to the cross-section shown in FIG. 3C above. In other words, the structure of FIG. 12A is ‘overcut’ around its sides and the structure of FIG. 12B is ‘undercut’ around its sides.

In FIGS. 12A and 12B, the line cs12a indicates the position of a cross section which would look similar to FIG. 3B, and the line cs12b indicates the position of a cross-section which would look similar to FIG. 3C. However, since the oblique sides extend around the whole rhombus shape, a cross-section between the two nearest corners of the rhombus would also look similar to FIG. 3B or FIG. 3C respectively.

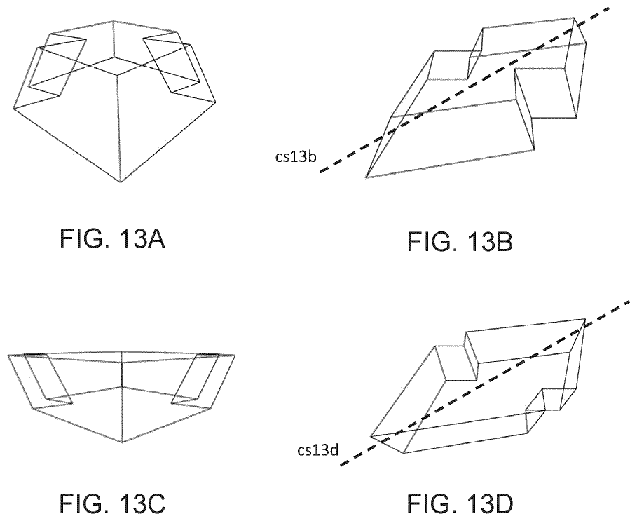

FIGS. 13A to 13D represent two variations of the structure shown in FIG. 11B, with oblique sides. In FIGS. 13A and 13B, a first variant is shown from an end-on perspective view and a side-on perspective view. In FIGS. 13A and 13B, the oblique sides are arranged such that an upper surface has a smaller area than a base of the optical structure. FIGS. 13A and 13B correspond to the cross-section shown in FIG. 3B above. In FIGS. 13C and 13D, a second variant is shown from an end-on perspective view and a side-on perspective view. In FIGS. 13C and 13D, the oblique sides are arranged such that the area of the upper surface is larger than the area of the lower surface. As a result, the sidewall of the nanostructure is described as having a negative slope, or an undercut. FIGS. 13C and 13D correspond to the cross-section shown in FIG. 3C above.

In FIGS. 13B and 13D, the line cs13b indicates the position of a cross section which would look similar to FIG. 3B, and the line cs13d indicates the position of a cross-section which would look similar to FIG. 3C. However, since the oblique sides extend around the whole rhombus shape, a cross-section between the two notches of the rhombus would also look similar to FIG. 3B or FIG. 3C respectively.

The structures with notches, as shown in FIGS. 8, 11B and 13A to 13D may exist as two permutations. In one variation, the notch length, n, is fixed in all x-y cross sections at any position along the z-axis. In another variation, the notch length, n, varies in proportion to the perimeter length or the area of the cross-section of the optical structure at any position along the z-axis.

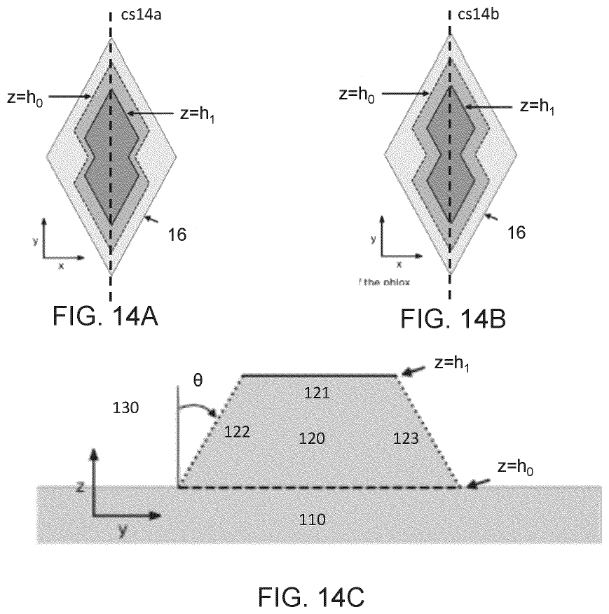

FIGS. 14A to 14C schematically illustrate cross-sections of further example optical structures, in the x-y and y-z planes. In particular, FIG. 14A and 14B are top views illustrating a base cross-section at z=h₀ and a top-cross-section at z=h₁, within a larger parallelogram 16 which is a unit area for a repeating pattern of optical structures. FIG. 14C is a side cross-section illustrating the sides in the y-z plane, corresponding to line cs14a or cs14b labelled in FIGS. 14A and 14B. It should be noted that the cross-section in FIG. 14C is in a y-z plane perpendicular to the x-z plane of FIGS. 3A to 3C and 4A to 4C. As shown best in FIG. 14C, the optical structure 120 again extends from a waveguide substrate layer 110 into a second substrate layer 130 (where the second substrate layer 130 is air in the case of a surface optical structure). As also shown in FIG. 14C, an angle θ between the vertical (z-direction, perpendicular to the planar surface of the waveguide substrate 110) and the first side edge 122 is greater than zero and less than 90 degrees.

FIGS. 14A and 14B differ in that, in FIG. 14A, a side length n of the notches decreases with height z above the waveguide substrate layer 110, whereas, in FIG. 14B, the side length n of the notches is fixed regardless of the height z above the waveguide substrate layer 110. This can be seen by looking at the corners of the notches in the y axis. In FIG. 14A, the corners of the notches at z=h₁ are closer together than the corners of the notches at z=h₀. On the other hand, in FIG. 14B, the corners of the notches at z=h₁ and at z=h₀ are spaced apart by the same distance.

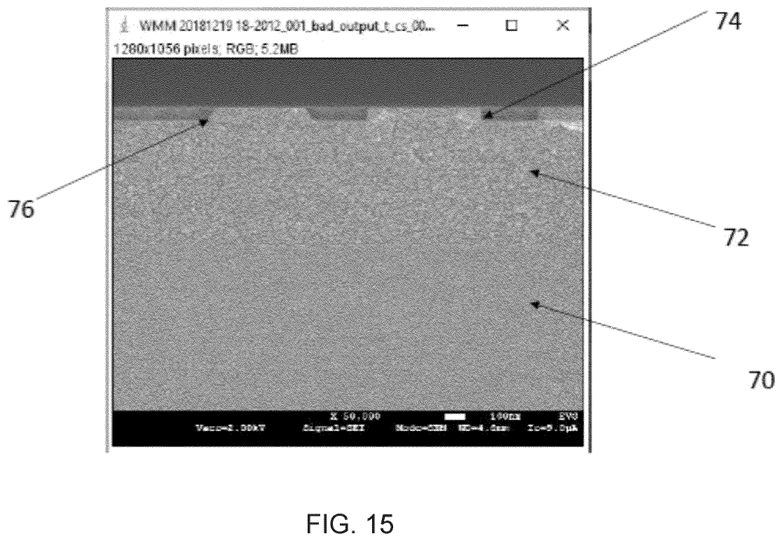

FIG. 15 shows a cross-sectional electron micrograph through a waveguide, in which can be seen the waveguide substrate 70, imprinted polymer layer 72 and nanostructures having vertical 74 and angled 76 sidewalls.

Various fabrication techniques could be used to achieve the overcut and undercut profiles described above. One example is through the use of grey-scale lithography, in which the mask used has an overcut profile which is then transferred down to the substrate material through anisotropic etching. Alternatively, a hard mask with vertical sidewalls could be utilised, and the etch process can be engineered to yield an undercut or overcut profile.

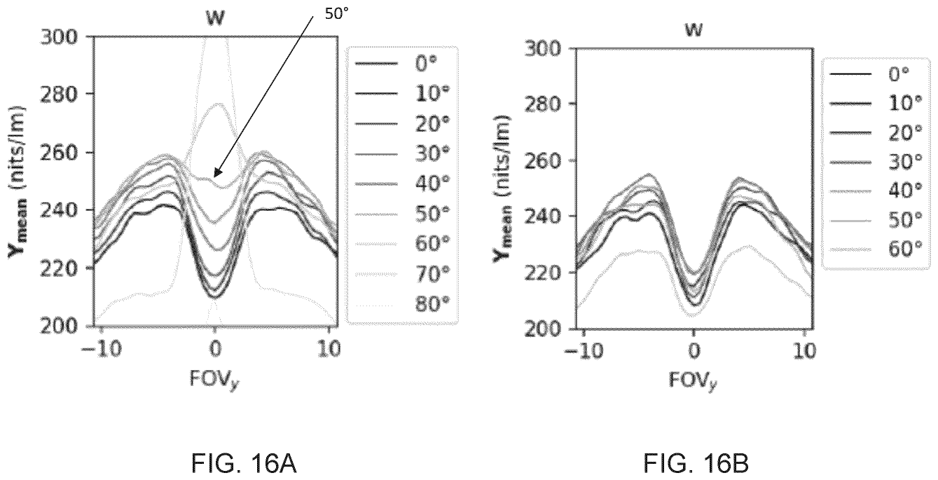

FIGS. 16A and 16B represent a series of simulations made using output regions consisting of arrays of nanostructures based on arrangements described with reference to FIGS. 14A and 14B. FIG. 16A represents a series of simulations made using arrays of nanostructures having variable size notches, corresponding to FIG. 14A, while FIG. 16B represents measurements made when the notches were of a fixed size, corresponding to FIG. 14B. The angular values depicted on the right-hand axis represent the increasing angular slope of the sidewall relative to the vertical, represented by θ in FIG. 14C. The darkest line at zero degrees represents a vertical sidewall, in which case the upper and lower surfaces of the nanostructure have equal areas. As the sidewall angle increases the upper surface area is reduced, until the structure is almost flattened.

The x-axis of FIGS. 16A and 16B represents the field of view (FOV) and the y-axis represents the average white light brightness across the FOV. In an ideal situation, the average luminance (nits/lumen) should be constant across the whole FOV, in particular in the centre of the FOV (about 0). The data indicate that the sidewall angle can be tuned to realise a close to ideal design, where the luminance is most uniform. In this example, this is achieved when the sidewall slope is around fifty degrees with a notch that has an edge length that varies with upper edge length (FIG. 16A, the plot labelled 50°, and also indicated using the legend). On the other hand, when the notch that has an edge length that varies with upper edge length and the sidewall angle is 70° from the vertical (the plot cut-off by the top of the figure), the average white light brightness is higher at the centre of the FOV than elsewhere. Additionally, when the sidewall angle is 0° (the bottom plot at the centre of the FOV), the average white light brightness is significantly lower at the centre of the FOV than elsewhere in the FOV. Furthermore, it can be seen that when the notch is held at a fixed size (FIG. 16B) the average white light luminance does not follow a desired profile, with each sidewall angle studied having a noticeable dip in brightness at the central FOV.

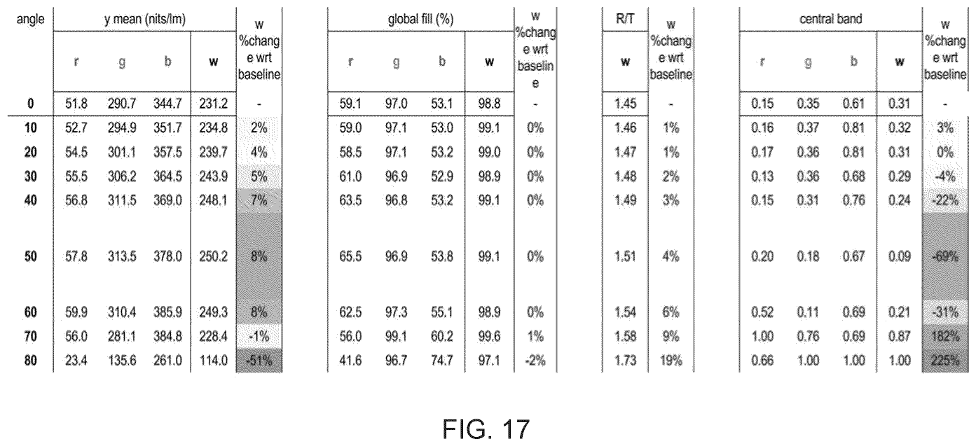

FIG. 17 is a table representing a set of examples of simulated data obtained from arrays of nanostructures with a notch that has an edge length that varies with z-position, for red (r), green (g), blue (b) and white (w) light. The data show the effect of varying the sidewall angle on the average luminance (nits/lumen) (column 1); the degree to which each colour of light fills the eyebox (global fill %) (column 2); the ratio of reflectance to transmittance (R/T) (column 3) and the appearance of a brighter central band across the eyebox (central band) (column 4). In each case the first row of data represents simulations made with a standard vertical sidewall, and subsequent simulations represent the effect observed as the sidewall angle is increased, which is essentially causing the nanostructure to become almost flattened. The final column of data in each simulation series represents a change in the measurement for white light as a percentage of the white light value measured when the nanostructure has a vertical sidewall. The data indicate that the most favourable improvement with respect to average brightness and the central band occurred with a sidewall angle of fifty degrees.

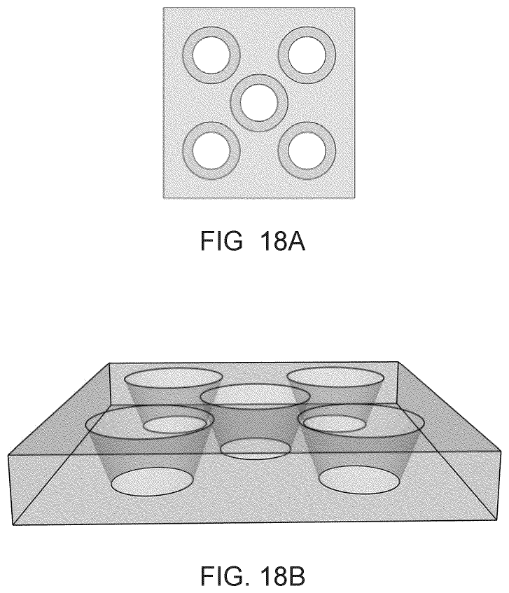

The consideration of sidewall profiles is not limited to diamond or notched diamond profiles and is also not limited to structures extruded out of the plane of the waveguide. As one example, in FIGS. 18A and 18B, a square lattice arrangement of nanostructures with circular inclusions are shown from top-facing and perspective views, indicating the frustoconical appearance of such nanostructures.

1. A waveguide for use in an augmented reality or virtual reality display, comprising:
a waveguide substrate layer having a planar surface; and
a plurality of optical structures extending into or out of the planar surface;
wherein the plurality of optical structures are arranged in an array to provide at least one diffractive optical element in the waveguide, and the at least one diffractive optical element is configured to receive light from an input direction within the plane of the waveguide and to diffract a portion of the received light out of the waveguide towards a viewer;
wherein, in a plane defined by the input direction and a direction perpendicular to the planar surface, at least one of the optical structures has a cross-section comprising a top edge, a first side edge and a second side edge, the first side edge extends from the planar surface to a leading end of the top edge, the top edge extends from the leading end in a major direction parallel to the input direction to a following end, and the second side edge extends from the following end of the top edge to the planar surface,
wherein:
the first side edge has a first oblique major direction away from the planar surface where the first oblique major direction is neither parallel to the planar surface nor perpendicular to the planar surface.

2. The waveguide of claim 1, wherein:
the second side edge has the second oblique major direction towards the planar surface where the second oblique major direction is neither parallel to the planar surface nor perpendicular to the planar surface; and
an angle between the first oblique major direction and the input direction is equal to an angle between the second oblique major direction and the input direction.

3. The waveguide of claim 1, wherein an angle between the first or second oblique major direction and the input direction is lower than 90°.

4. The waveguide of claim 1, wherein an angle between the first or second oblique major direction and the input direction is greater than 90°.

5. The waveguide of claim 1, wherein, the plurality of optical structures are arranged at different positions with different displacements in the input direction, and an angle between the first or second major direction and the input direction decreases as a function of displacement in the input direction for each respective optical structure.

6. The waveguide of claim 1, wherein the at least one of the optical structures comprises an optical coating.

7. The waveguide of claim 6, wherein:
an angle between the first oblique major direction and the input direction is greater than or
equal to 90°, and the coating is provided on the first side edge; or
an angle between the second oblique major direction and the input direction is greater than or
equal to 90°, and the coating is provided on the second side edge.

8. The waveguide of claim 1, wherein, at the at least one diffractive optical element, the planar surface is an air interface.

9. The waveguide of claim 1, wherein, at the at least one diffractive optical element, the planar surface is an interface between two substrates having different refractive indices.

10. The waveguide of claim 1, wherein:
the plurality of optical structures are arranged in an array to provide at least two diffractive optical elements overlaid on one another on or in the waveguide;
each of the two diffractive optical elements is configured to receive light from an input direction and couple it towards the other diffractive optical element which can then act as an output diffractive optical element providing outcoupled orders towards a viewer; and
the at least one of the plurality of optical structures has a shape, when viewed in the plane of the waveguide, comprising a plurality of substantially straight sides having respective normal vectors at different angle.

11. The waveguide of claim 10, wherein, when viewed in the plane of the waveguide, one of the sides has a length that is a ratio of around 0.1 to 0.4 of the spacing of optical structures in the array.

12. The waveguide of claim 10, wherein, when viewed in the plane of the waveguide, the at least one optical structure includes sides that are substantially parallel to the two respective diffractive optical elements.

13. The waveguide of claim 10, wherein, when viewed in the plane of the waveguide, the at least one optical structure includes sides that are angled at substantially ±30° to the input direction.

14. The waveguide of claim 10, wherein:
when viewed in one of plurality of planes parallel to the plane of the waveguide and offset by different distances z from the plane of the waveguide, the at least one optical structure has a parallelogram shaped structure;
at least one corner of the parallelogram is inverted to protrude inward rather than outward, forming a notch having sides of length n; and
either:
n is fixed regardless of the distance z; or
n varies as a function of the distance z.

15. The waveguide of claim 10, wherein when viewed in one of a plurality of planes parallel to the plane of the waveguide and offset by different distances z from the planar surface:
a perimeter of the optical structure increases as a function of the distance z; or
a perimeter of the optical structure decreases as a function of the distance z.

16. The waveguide of claim 10, wherein the input direction defines an input axis, and the optical structures have different shapes at positions which are tangentially displaced from the input axis in the plane of the waveguide.

17. The waveguide of claim 1, comprising an input diffractive optical element configured to couple light into the waveguide and to provide light to the plurality of optical structures in the array in the input direction.

18. The waveguide of claim 10, wherein:
the second side edge has a second oblique major direction towards the planar surface where the second oblique major direction is neither parallel to the planar surface nor perpendicular to the planar surface.

19. The waveguide of claim 18, wherein:
an angle between the first oblique major direction and the input direction is equal to an angle between the second oblique major direction and the input direction.

20. The waveguide of claim 1, wherein:
the second side edge has a second oblique major direction towards the planar surface where the second oblique major direction is neither parallel to the planar surface nor perpendicular to the planar surface.
